(19) United States
(12) Patent Application Publication
(10) Pub. No.: US 2026/0355053 A1
(43) Pub. Date: Nov. 12, 2026

(54) MASSAGING DEVICE

(71) Applicant: Chongqing Hemiao Network Technology Co., Ltd., Chongqing (CN)

(72) Inventors: Weimin WANG, Chongqing (CN); Zhengsheng ZHOU, Shenzhen (CN); Guoxu WANG, Maoming (CN)

(73) Assignee: Chongqing Hemiao Network Technology Co., Ltd., Chongqing (CN)

(21) Appl. No.: 19/231,457

(22) Filed: Jun. 7, 2025

(30) Foreign Application Priority Data
May 12, 2025 (CN) 2025209223051

(51) Int. Cl. A61H 23/02

(52) U.S. Cl. CPC A61H 23/02; A61H 2201/1207; A61H 2201/1652; A61H 2205/082

(57) ABSTRACT

A massaging device, including a massaging component, the massaging component includes a driving component and a first massaging assembly, the driving component is connected to a first end of the first massaging assembly; the driving component is configured to drive the first massaging assembly to vibrate; the first massaging assembly includes a hollow portion, which runs through a thickness direction of the first massaging assembly; and a connecting component, wherein the connecting component is connected to a second end of the first massaging assembly; the connecting component is configured to fix the first massaging assembly to a user's area to be massaged; when the massaging device is in a wearing state, the first massaging assembly is configured to deform and adhere to the user's area to be massaged.

### CROSS-REFERENCE TO RELATED APPLICATIONS

This application claims foreign priority of Chinese Patent Application No. 202520922305.1, filed on May 12, 2025 in the China National Intellectual Property Administration, the disclosures of all of which are hereby incorporated by reference.

### TECHNICAL FIELD

The present disclosure relates to the technical field of massage equipment, in particular to a massaging device.

### BACKGROUND

Currently, most body-covering massaging devices on the market feature a wrap-around design, which closely fits the area to be massaged. They utilize methods such as mechanical vibrations, pneumatic pulses, or heat disclosures to achieve precise stimulation of acupoints or muscle tissues.

Due to the enclosed cavity design of the structure, when used for extended periods (typically more than 20-30 minutes), the heat and water vapor emitted by the user's skin cannot be expelled promptly, as the massage area remains in a sealed cavity. This can cause sweat to accumulate on the skin's surface, leading to a stuffy sensation in the massaged area. This affects both hygiene and user experience. Prolonged localized heat retention may even result in the expansion of capillaries in the epidermis, causing bruising and potentially impacting the user's physical health.

### SUMMARY

The present disclosure provides a massaging device, to improve the stuffiness of the massage area and enhance user comfort during use.

The present disclosure provides a massaging device, including: a massaging component, wherein the massaging component includes a driving component and a first massaging assembly, the driving component is connected to a first end of the first massaging assembly; the driving component is configured to drive the first massaging assembly to vibrate; the first massaging assembly includes a hollow portion, which runs through a thickness direction of the first massaging assembly; and a connecting component, wherein the connecting component is connected to a second end of the first massaging assembly; the connecting component is configured to fix the first massaging assembly to a user's area to be massaged; when the massaging device is in a wearing state, the first massaging assembly is configured to deform and adhere to the user's area to be massaged.

Furthermore, the first massaging assembly is in a spiral shape or a mesh shape.

Furthermore, the first massaging assembly includes a core layer and an outer covering layer, the core layer is enveloped by the outer covering layer, and a hardness of the outer covering layer is less than that of the core layer.

Furthermore, the massaging component further includes a second massaging assembly, which is connected to the driving component, and the driving component is configured to drive the second massaging assembly to vibrate; when the massaging device is in a wearing state, the second massaging assembly is configured to contact the user's area to be massaged.

Furthermore, the second massaging assembly includes multiple flexible contacting heads, and the multiple flexible contacting heads extend in a direction away from the driving component; and an enclosed space is define by the multiple flexible contacting heads; a gap is defined between two adjacent flexible contacting heads, and the gap connects the enclosed space with an external environment.

Furthermore, the second massaging assembly and the driving component are located in a central area of the first massaging assembly.

Furthermore, wherein one of the second massaging assembly and the driving component is provided with a magnetic element; the second massaging assembly and the driving component are magnetically connected.

Furthermore, the driving component includes a housing and a driving part, the driving part is sealed within the housing; the driving part is connected to the first end and the second massaging assembly, and is configured to drive the first massaging assembly and the second massaging assembly to vibrate.

Furthermore, at least part of the first end is clamped between the housing and the second massaging assembly.

Furthermore, the connecting component includes a first strap and a second strap; the massaging device includes two massaging components, with both ends of the first strap connected to two first massaging assemblies of the two massaging components; both ends of the second strap are connected to the two first massaging assemblies of the two massaging components; and for one of the massaging components, the second end of the first massaging assembly is connected to the first end of the first strap; and for another massaging component, the second end of the first massaging assembly is connected to the other end of the first strap; a length of the first strap is shorter than that of the second strap.

The massaging device of the present disclosure, the first massaging assembly is deformed and adhered to a massage area, and the hollow portion can effectively provide ventilation and air permeability, avoiding stuffiness in the massage area and improving user comfort. Moreover, the first massaging assembly can adaptively deform according to the shape of the massage area to fit the user's area to be massaged, which is conducive to improving the comprehensiveness and effectiveness of the massage and further enhancing user comfort.

### BRIEF DESCRIPTION OF DRAWINGS

FIG. 1 is a schematic structural diagram of a massaging device according to an embodiment of the present disclosure.

FIG. 2 is a schematic structural diagram of the massaging device in FIG. 1 from another view.

FIG. 3 is a schematic structural diagram of a massaging component of the massaging device.

FIG. 4 is a schematic structural diagram of a first massaging assembly of the massaging device.

FIG. 5 is a schematic structural diagram of the first massaging assembly of the massaging device in FIG. 4 from another view.

FIG. 6 is a cross sectional view of the first massaging assembly.

FIG. 7 is a schematic structural diagram of the massaging component of the massaging device of FIG. 3 from another view.

FIG. 8 is a schematic structural diagram of the first massaging assembly of the massaging device in FIG. 5 from another view.

FIG. 9 is a section view of the massaging component of the massaging device along A-A line of FIG. 3.

FIG. 10 is a schematic structural diagram of the massaging component according to an embodiment of the present disclosure.

FIG. 11 is a schematic structural diagram of the massaging component in FIG. 10 from another view.

FIG. 12 is a schematic structural diagram of the second massaging assembly according to an embodiment of the present disclosure.

FIG. 13 is a schematic structural diagram of the second massaging assembly in FIG. 12 from another view.

### DESCRIPTION OF THE REFERENCE NUMERAL

| | reference | | reference |
|---|---|---|---|
| Description | numeral | Description | numeral |
| massaging device | 100 | massaging component | 10 |
| driving component | 11 | housing | 111 |
| driving part | 112 | transmission part | 117 |
| battery | 113 | circuit board | 114 |
| switch button | 115 | magnetic element | 116 |
| first massaging assembly | 12 | first end | 121 |
| second end | 122 | hollow portion | 123 |
| core layer | 124 | outer covering layer | 125 |
| second massaging | 13 | flexible contacting | 131 |
| assembly | | head | |
| enclosed space | 132 | metal block | 133 |
| gap | 134 | connecting component | 20 |
| first strap | 21 | first part | 211 |
| second part | 212 | second strap | 22 |
| third part | 221 | fourth part | 222 |
| third strap | 23 | fifth part | 231 |
| sixth part | 232 | | |

The following detailed implementation will be further explained in conjunction with the above figures to illustrate the present disclosure.

### DETAILED DESCRIPTION OF THE EMBODIMENTS

The following will describe the technical solutions in the embodiments of this disclosure in conjunction with the figures of the embodiments. Apparently, the described embodiments are only a part of the embodiments of the present disclosure and not all of the embodiments.

It should be noted that when an element is considered to be “connected” to another element, it can be directly connected to another element or may have an element centered between them. When an element is considered to be “set” on another element, it can be directly set on another element or may have an element centered between them.

In the description of the embodiments of this disclosure, the technical terms “first”, “second”, etc. are used merely to distinguish different objects and should not be understood as indicating or implying relative importance, or suggesting the number, specific order, or hierarchical relationship of the indicated technical features. In the description of the embodiments of this disclosure, the meaning of “multiple” is more than two, unless otherwise explicitly specified.

It should also be noted that the thickness, length, width, and other dimensions of various components shown in the figures of this disclosure, as well as the overall thickness, length, and width of the integrated device, are only for illustrative purposes and should not be considered as limiting the present disclosure.

The following further describes the embodiments of the present disclosure in conjunction with the figures.

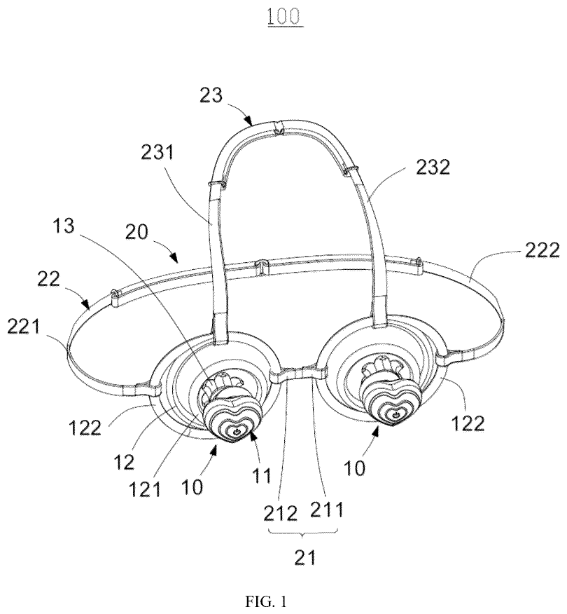

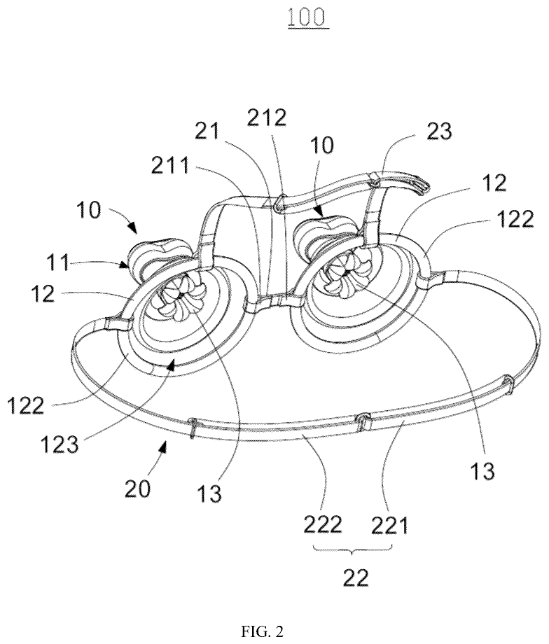

As shown in FIGS. 1 and 2, an embodiment of this disclosure provides a massaging device 100, which includes a massaging component 10 and a connecting assembly 20 that are interconnected. The connecting assembly 20 is used to connect to the user's area to be massaged, enabling the massaging component 10 to be stably worn on the user and connected to the part of the body to be massaged, for performing vibration massage on the target massage area. Usually the connecting assembly 20 is connect to skin of breasts, especially those of adult women.

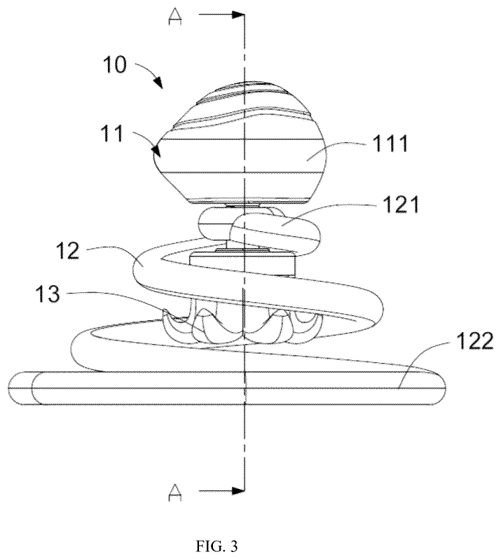

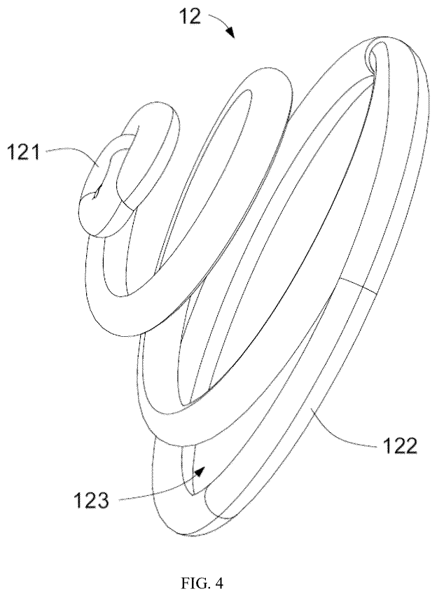

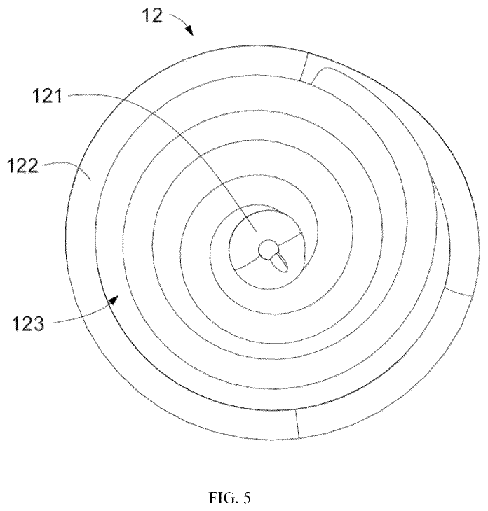

As shown in FIGS. 2 to 5, in one embodiment, the massaging component 10 includes a driving component 11 and a first massaging assembly 12. The driving component 11 is connected to a first end 121 of the first massaging assembly 12. The driving component 11 is configured to drive the first massaging assembly 12 to vibrate. The first massaging assembly 12 includes a hollow portion 123, which extends through the thickness direction of the first massaging assembly 12. When the massaging device 100 is in the wearing state, the first massaging assembly 12 is configured to deform and fit against the target massage area, that is, the user's area to be massaged.

In the present embodiment, the first massaging assembly 12 can deform adaptively according to the shape of the target massage area to fit the area, which helps improve the user's comfort. Additionally, the hollow portion 123 on the first massaging assembly 12 can provide ventilation, preventing a stuffy feeling at the massage area, further improving the user's comfort.

In one embodiment, when viewed along a thickness direction of the first massaging assembly 12, the first massaging assembly 12 is arranged in a spiral or mesh shape. The spiral or mesh shape of the first massaging assembly 12 allows for better deformability, adapting to the shape of the target massage area, thereby improving comfort. Additionally, during a massage process, the force generated by the driving component 11 is transmitted along the shape of the first massaging assembly 12, with the intensity weakening as the distance increases, providing varying levels of stimulation to the target massage area.

In one embodiment, the spiral-shaped first massaging assembly 12 can be manufactured based on a principle of the Archimedean spiral.

In one embodiment, the first end 121 is located at a center of the first massaging assembly 12, that is, the driving component 11 is connected to a central region of the first massaging assembly 12. When the first massaging assembly 12 is spiral or mesh-shaped, the driving component 11 is connected to the central region of the first massaging assembly 12, beneficial for centering a center of gravity of the massage component 10, making it easier for the user to wear. Further, when the first massaging assembly 12 is spiral, the vibration generated by the driving component 11 is transmitted from the center of the first massaging assembly 12 along the spiral towards the outer edges, forming a wide, circumferential massaging motion that helps improve the comprehensiveness and effectiveness of the massage.

In one embodiment, the connecting assembly 20 is connected to the second end 122 of the first massaging assembly 12. When viewed along the thickness direction of the first massaging assembly 12, and when the first massaging assembly 12 is spiral or mesh-shaped, the first end 121 is located at the central region of the first massaging assembly 12, and the second end 122 is located at the edge region.

Further, when the first massaging assembly 12 is spiral, the first end 121 is located at an innermost ring of the spiral structure, and the second end 122 is located at an outermost ring of the spiral structure. When the first massaging assembly 12 is mesh-shaped, the first end 121 is located at the innermost ring or near the center of the mesh structure, and the second end 122 is located at the outermost ring of the mesh structure.

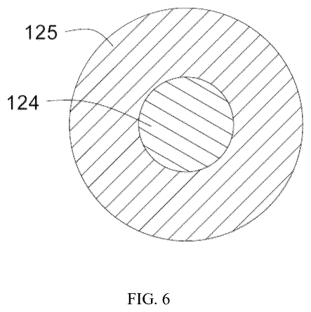

As shown in FIG. 6, in one embodiment, the first massaging assembly 12 includes a core layer 124 and an outer covering layer 125. The outer covering layer 125 is coated on the core layer 124, and the hardness of the outer covering layer 125 is less than that of the core layer 124. When the massaging device 100 is in the wearing state, the softer outer covering layer 125 is used to connect or contact the user's body, improving the user's skin comfort. Additionally, the harder core layer 124 provides a better support, preventing the first massaging assembly 12 from becoming too soft to transmit vibrations effectively.

In one embodiment, the outer covering layer 125 is made of rubber or silicone. In one embodiment, the core layer 124 is made from any one of metal, alloy, or elastic plastic materials.

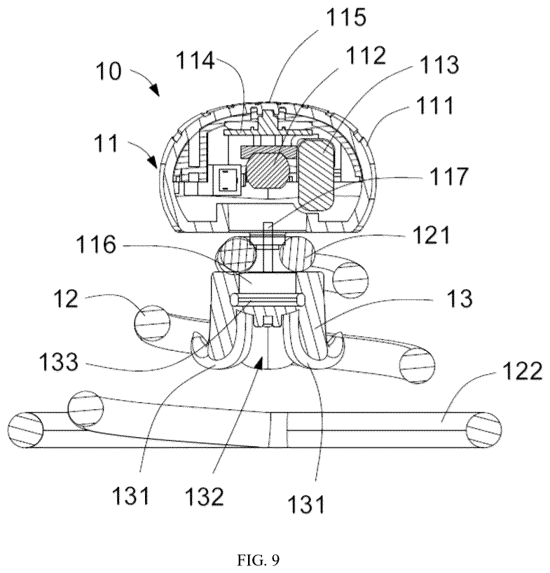

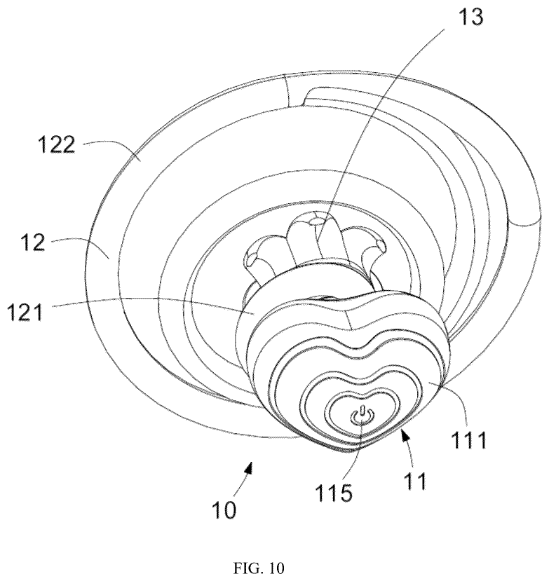

As shown in FIGS. 9 and 10, in one embodiment, the driving component 11 includes a housing 111 and a driving part 112. The driving part 112 is placed inside the housing 111, and the driving part 112 is connected to the first end 121 of the first massaging assembly 12. The driving part 112 is configured to drive the first massaging assembly 12 to vibrate. In one embodiment, the driving part 112 is an electric motor. In one embodiment, the driving part 112 is sealed inside the housing 111, helping reduce the risk of external debris or water entering the housing 111 and affecting the driving part 112.

In one embodiment, the driving component 11 also includes a transmission part 117, which connects the driving part 112 and the first end 121. The transmission part 117 transmits the vibration generated by the driving part 112 to the first massaging assembly 12.

In one embodiment, the driving component 11 also includes a battery 113, which is placed inside the housing 111 and connected to the driving part 112. The battery 113 provides power to the driving part 112.

In one embodiment, the driving component 11 also includes a circuit board 114, which is placed inside the housing 111 and connects the battery 113 and the driving part 112.

In one embodiment, the circuit board 114 has a built-in driving program, enabling the driving part 112 to output vibrations with different intensities or frequencies, allowing the first massaging assembly 12 to have varying vibration intensities or frequencies, thus providing different massage modes.

In one embodiment, the driving component 11 further includes a switch button 115, which is located on the housing 111. When the switch button 115 is pressed, the switch button 115 is physically connected to a trigger button on the circuit board 114 to control the operation of the massaging assembly 10, or when the switch button 115 is pressed, the switch button 115 is electrically connected to the circuit board 114 and triggers the circuit board 114 to control the operation of the massaging assembly 10.

In one embodiment, the driving component 11 further includes a wireless communication module (not shown in the figure). The wireless communication module is located inside the housing 111 and electrically connected to the circuit board 114. The user can connect to the wireless communication module via a wireless terminal (such as a smartphone or remote control), thereby controlling the massaging assembly 10. In one embodiment, the wireless communication module is located on the circuit board 114.

As shown in FIGS. 9 to 11, in one embodiment, the massaging assembly 10 further includes a second massaging component 13, which is connected to the transmission part 117. The driving component 112 is further configured to drive the second massaging component 13 to vibrate via the transmission part 117.

When the massaging device 100 is in a wearing state, the second massaging component 13 is configured to press against the user's area to be massaged. At this time, the spiral or mesh shaped first massaging component 12 can serve as a cup-shaped massage structure to create a circumferential vibrating massage on the breast, the user's area to be massaged, while the second massaging component 13 can serve as a contact or localized massage structure to create a localized vibrating massage on the area to be massaged. Both components work together, which helps to create different massage sensations, enhancing the overall massage effect and improving the user's experience.

In one embodiment, under the driving of the driving component 112, the transmission part 117 is configured to move longitudinally relative to the housing 111, thereby driving the first massaging component 12 and the second massaging component 13 to perform a pressing vibration massage mode on the area to be massaged.

In one embodiment, under the drive of the driving component 112, the transmission part 117 is configured to move transversely relative to the housing 111, thereby driving the first massaging component 12 and the second massaging component 13 to perform a transverse vibration massage mode on the area to be massaged.

In one embodiment, any of the massaging devices 100 of the present disclosure can be used to massage the user's head, legs, buttocks, or breasts.

When the massaging device 100 is used for head massage, the first massaging component 12 can cover the head, providing a circumferential, large-area massage for the head, while the second massaging component 13 can be connected to a specific local area or acupoint on the head to perform targeted massage.

When the massaging device 100 is used for breast massage, the first massaging component 12 can cover the breast to provide a circumferential massage, while the second massaging component 13 can act on the nipple or the area around the nipple to perform localized massage.

When the massaging device 100 is used for buttock massage, the first massaging component 12 can cover the buttocks, providing a circumferential massage, while the second massaging component 13 can be connected to a specific local area or acupoint on the buttocks to perform targeted massage.

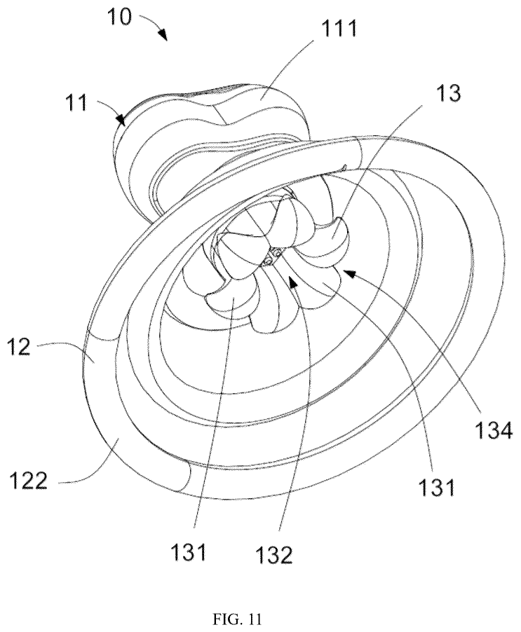

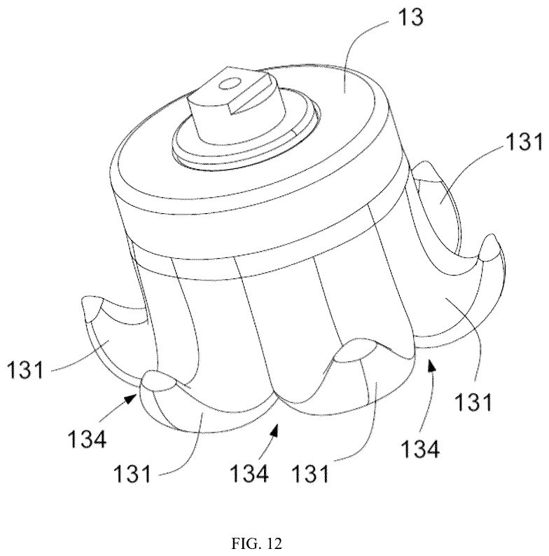

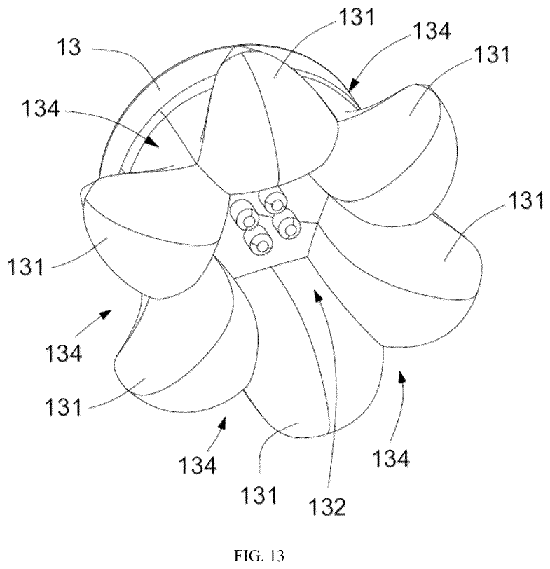

As shown in FIGS. 11 to 13, in one embodiment, the second massaging component 13 includes multiple flexible contacting head 131, which extend in the direction away from the driving component 11, and both the flexible contacting head 131 and the first massaging component 12 are located on a same side of the driving component 11. By providing multiple flexible contacting head 131 on the second massaging component 13, the pressing sensation of the second massaging component 13 is improved, enhancing the massage effect of the second massaging component 13.

In one embodiment, the multiple flexible contacting head 131 are arranged circumferentially and form an accommodating space 132. When the massaging device 100 is used for breast massage, the accommodating space 132 can be used to accommodate the nipple of the breast. The multiple flexible contacting head 131 massage the nipple in a circumferential manner, which helps reduce pressure on the nipple, improving the user's comfort. When the massaging device 100 is used for head massage, the accommodating space 132 can form a space to hold air, preventing the second massaging component 13 from making large-area contact with the head, which could cause a stuffy feeling, thus enhancing comfort.

In one embodiment, there is a gap 134 between two adjacent flexible contacting heads 131. The gap 134 allows the accommodating space 132 to communicate with the outside, and when the second massaging component 13 is applied to the area to be massaged, the gap 134 allows air inside the accommodating space 132 to circulate with the outside, improving the breathability of the second massaging component 13 and enhancing the comfort of the massage.

In one embodiment, the flexible contacting heads 131 are made of rubber or silicone.

As shown in FIGS. 9 and 10, in one embodiment, when observed along a thickness direction of the first massaging component 12, the second massaging component 13 is located in a center region of the first massaging component 12. When the massaging device 100 is in a wearing state, the second massaging component 13 acts on the central local area of the area to be massaged, while the first massaging component 12 acts on the peripheral area of the area to be massaged, excluding the central region. Both components work together to improve the comprehensiveness of the massage, thereby enhancing the user's experience.

In one embodiment, the second massaging component 13 and the massaging assembly 10 are detachably connected, allowing the user to remove the second massaging component 13 for cleaning, reducing the impact on the driving component 11 during cleaning and extending the lifespan of the driving component 11. Furthermore, by replacing second massaging components 13 of different shapes, the massaging device 100 can be diversified, improving the variety of massage modes.

In one embodiment, one of the second massaging component 13 and the driving component 11 is provided with a magnetic element 116, and the second massaging component 13 is magnetically connected to the driving component 11. This connection method facilitates assembly and disassembly. In one embodiment, the magnetic element 116 is located on the driving component 11, and a metal block 133 is located on the second massaging component 13. The second massaging component 13 and the driving component 11 are magnetically connected through the metal block 133 and the magnetic element 116. Further, the magnetic element 116 is connected to the transmission part 117. In one embodiment, the metal block 133 is an iron sheet.

In one embodiment, one of the second massaging assemblies 13 and the driving component 11 is provided with a limiting slot, while the other is equipped with an elastic limiting part. At least a part of the elastic limiting part extends into the limiting slot and elastically snaps into place within the limiting slot (the figure is not shown). When it is necessary to separate the second massaging assemblies 13 and the driving component 11, pressure can be applied to the elastic limiting part, causing it to elastically deform and separate from the limiting slot. At this point, the elastic limiting part can be removed from the limiting slot, allowing the second massaging assemblies 13 and the driving component 11 to be separated. This embodiment is not only convenient to operate, but also helps to improve the connection stability between the second massaging assemblies 13 and the driving component 11. In one embodiment, the elastic limiting part is located on the driving component 11, and the limiting slot is located on the second massaging assemblies 13.

In another embodiment, one of the second massaging assemblies 13 and the driving component 11 is provided with a first buckle, and the other is provided with a second buckle. The first and second buckles can be detachably snapped together (the figure is not shown). By snapping or separating the first and second buckles, the second massaging assemblies 13 and the driving component 11 can be connected or separated, making operation easier.

In another embodiment, at least part of the first end 121 is clamped between the housing 111 and the second massaging assemblies 13, so that the vibration generated by the driving component 112 is transmitted simultaneously to the first massaging assemblies 12 and the second massaging assemblies 13. Furthermore, the first end 121 can be sleeved and connected to the transmission part 117.

As shown in FIGS. 1 and 2, in one embodiment, the massaging device 100 includes two massaging components 10, and the connecting component 20 includes a first strap 21. Both ends of the first strap 21 are connected to the second ends 122 of the first massaging assemblies 12 in the two massaging components 10. The two massaging components 10 are connected into one whole by the first strap 21. When the massaging device 100 is in wearing state, the two massaging components 10 can correspond to two areas of the user's body, improving the user's comfort. Additionally, the connection via the first strap 21 helps reduce the risk of losing one of the massaging components 10.

In one embodiment, a length of the first strap 21 is adjustable, which allows the massaging device 100 to be adapted to different areas of the user's body and to users with different body sizes.

In one embodiment, the first strap 21 is an elastic band or a ribbon.

In one embodiment, the first strap 21 includes a first part 211 and a second part 212. The first part 211 is connected to the second end 122 of the first massaging assemblies 12 of one massaging component 10, and the second part 212 is connected to the second end 122 of the first massaging assemblies 12 of the other massaging component 10. The first part 211 and the second part 212 are detachably connected through a knot or hook. By adjusting the connection position between the first part 211 and the second part 212, the length of the first strap 21 can be adjusted, and thus the distance between the two massaging components 10 can be adjusted to suit users of different body sizes or to allow the user to massage different areas, such as breast, head or buttock.

In one embodiment, the connecting component 20 also includes a second strap 22, with both ends of the second strap 22 connected to the second end 122 of the first massaging assemblies 12 in the two massaging components 10. The length of the second strap 22 is greater than that of the first strap 21. When the massaging device 100 is in wearing state, the first strap 21, one massaging component 10, the second strap 22, and the other massaging component 10 are sequentially connected to form a closed ring. This closed ring is arranged and connected around the user's body, allowing the two massaging components 10 to be stably connected to the user's body.

In one embodiment, a length of the second strap 22 is adjustable, allowing the circumference of the aforementioned closed ring to be adjusted. This makes the massaging device 100 adaptable to users with different body sizes and helps avoid the user feeling overly restricted or loose, enhancing user comfort.

In one embodiment, the second strap 22 is an elastic band or a ribbon.

In one embodiment, the second strap 22 includes a third part 221 and a fourth part 222. The third part 221 is connected to the second end 122 of the first massaging assemblies 12 of one massaging component 10, and the fourth part 222 is connected to the second end 122 of the first massaging assemblies 12 of the other massaging component 10. The third part 221 and the fourth part 222 are detachably connected through a knot or hook. By adjusting the connection position between the third part 221 and the fourth part 222, the length of the second strap 22 can be adjusted, and thus the circumference of the closed ring can be modified.

In one embodiment, on the same second end 122 of the first massaging assemblies 12, the part connected to the first strap 21 and the part connected to the second strap 22 are located on opposite sides of the first end 121.

In one embodiment, the connecting component 20 includes a third strap 23 in addition to the first strap 21 and the second strap 22 as described in the previous embodiments. The third strap 23 has both ends connected to the second end 122 of the first massaging assemblies 12 in the two massaging components 10, and a length of the third strap 23 is greater than that of the first strap 21. When the two massaging components 10 are laid flat on a surface and the first strap 21 is extended, both ends of the third strap 23 are positioned on the same side of the two massaging components 10.

When the massaging device 100 is used to massage the chest and is in a worn state, the first massaging assemblies 12 of the two massaging components 10 are respectively placed over the user's two breasts. The first strap 21 is positioned across the user's chest, the second strap 22 is wrapped around the user's torso, and the third strap 23 is wrapped from the user's chest around the neck and connected to the back of the neck. The first strap 21, the second strap 22, and the third strap 23 work together to stably connect the massaging device 100 to the user's body.

In one embodiment, the third strap 23 is an elastic band or a ribbon.

In one embodiment, the third strap 23 includes a fifth part 231 and a sixth part 232. The fifth part 231 is connected to the second end 122 of the first massaging assemblies 12 of one massaging component 10, and the sixth part 232 is connected to the second end 122 of the first massaging assemblies 12 of the other massaging component 10. The fifth part 231 and the sixth part 232 are detachably connected through a knot or hook. By adjusting the connection position between the fifth part 231 and the sixth part 232, the length of the third strap 23 can be adjusted, further improving user comfort.

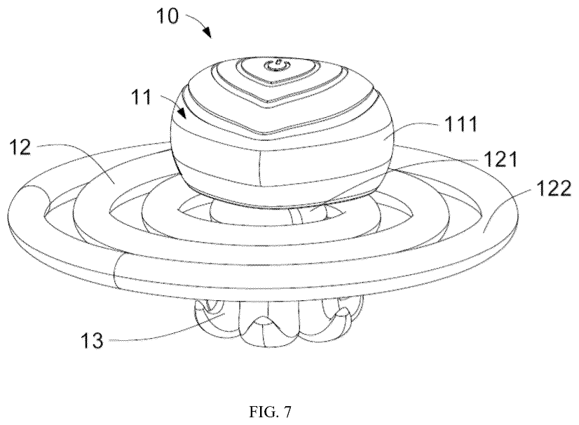

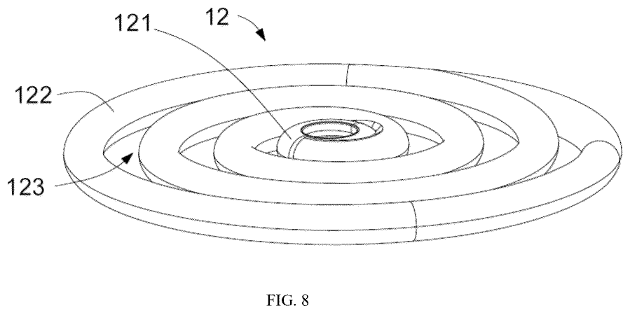

As shown in FIGS. 1-4, FIGS. 7-8, in one embodiment, when the massaging device 100 is in an un-worn state and not under external force, the first massaging assemblies 12 forms a flat spiral shape (as shown in FIGS. 7 and 8) or an approximately flat spiral shape, making it easy to store the massaging device 100. When the massaging device 100 is worn and positioned on the user's chest, the second massaging assemblies 13 acts on the nipple area, the first massaging assemblies 13 acts on the breast, and under the support of the chest and the stretching force of the second strap 22, the first massaging assemblies 13 undergoes elastic deformation and forms a tower-like shape (as shown in FIGS. 1 to 4) that adheres to the breast. This forms a bra-like covering over the breast, providing a comprehensive circumferential massage while also supporting the breast, reducing the risk of excessive sagging or shaking.

It should be further explained that the first massaging assemblies 12 in this disclosure has elastic properties. Therefore, if the user feels discomfort or needs to adjust the position during the massage, they can directly pull the driving component 11 outward. At this point, the first end 121 of the first massaging assemblies 12 will temporarily separate from the massage area. After releasing the pressure, the first massaging assemblies 12 will return to its original position.

In summary, in the massaging device 100 provided by this disclosure, after the first massaging assemblies 12 deforms and conforms to the massage area, the hollow part 123 can effectively serve as a ventilation and breathability function, preventing the massage area from feeling stuffy, thus improving user comfort. Additionally, the first massaging assemblies 12 can deform adaptively according to the shape of the massage area to fit the area to be massaged, which helps improve the comprehensiveness and effectiveness of the massage, as well as further enhancing user comfort.

The above description is merely one specific embodiment of this disclosure, and the scope of protection of this disclosure is not limited to this. Any modifications or substitutions within the technical scope disclosed in this disclosure should be covered by the disclosure of this disclosure.

What is claimed is:

1. A massaging device, comprising:
a massaging component, wherein the massaging component comprises a driving component and a first massaging assembly, the driving component is connected to a first end of the first massaging assembly; the driving component is configured to drive the first massaging assembly to vibrate; the first massaging assembly comprises a hollow portion, which runs through a thickness direction of the first massaging assembly; and
a connecting component, wherein the connecting component is connected to a second end of the first massaging assembly; the connecting component is configured to fix the first massaging assembly to a user's area to be massaged; when the massaging device is in a wearing state, the first massaging assembly is configured to deform and adhere to the user's area to be massaged.

2. The massaging device according to claim 1, wherein the first massaging assembly is in a spiral shape or a mesh shape.

3. The massaging device according to claim 1, wherein the first massaging assembly comprises a core layer and an outer covering layer, the core layer is enveloped by the outer covering layer, and a hardness of the outer covering layer is less than that of the core layer.

4. The massaging device according to claim 1, wherein the massaging component further comprises a second massaging assembly, which is connected to the driving component, and the driving component is configured to drive the second massaging assembly to vibrate;
when the massaging device is in a wearing state, the second massaging assembly is configured to contact the user's area to be massaged.

5. The massaging device according to claim 4, wherein the second massaging assembly comprises multiple flexible contacting heads, and the multiple flexible contacting heads extend in a direction away from the driving component; and
an enclosed space is defined by the multiple flexible contacting heads;
a gap is defined between two adjacent flexible contacting heads, and the gap connects the enclosed space with an external environment.

6. The massaging device according to claim 4, wherein the second massaging assembly and the driving component are located in a central area of the first massaging assembly.

7. The massaging device according to claim 4, wherein one of the second massaging assembly and the driving component is provided with a magnetic element; the second massaging assembly and the driving component are magnetically connected.

8. The massaging device according to claim 4, wherein the driving component comprises a housing and a driving part, the driving part is sealed within the housing; the driving part is connected to the first end and the second massaging assembly, and is configured to drive the first massaging assembly and the second massaging assembly to vibrate.

9. The massaging device according to claim 8, wherein at least part of the first end is clamped between the housing and the second massaging assembly.

10. The massaging device according to claim 1, wherein the connecting component comprises a first strap and a second strap;
the massaging device comprises two massaging components, with both ends of the first strap connected to two first massaging assemblies of the two massaging components; both ends of the second strap are connected to the two first massaging assemblies of the two massaging components; and
for one of the massaging components, the second end of the first massaging assembly is connected to the first end of the first strap; and for another massaging component, the second end of the first massaging assembly is connected to the other end of the first strap;
a length of the first strap is shorter than that of the second strap.
